(19) United States
(12) Patent Application Publication
(10) Pub. No.: US 2006/0066603 A1
(43) Pub. Date: Mar. 30, 2006

(54) Display device and display method

(75) Inventors: Toshio Obayashi, Hiratsuka-shi (JP); Tsutomu Sakamoto, Fukaya-shi (JP); Takayuki Arai, Hiratsuka-shi (JP); Yasuhiro Ookawara, Oume-shi (JP); Masao Yanamoto, Ichihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/211,714

(22) Filed: Aug. 26, 2005

(30) Foreign Application Priority Data
Sep. 30, 2004 (JP) P2004-289378

(51) Int. Cl. G09G 5/00

(52) U.S. Cl. 345/204

(57) ABSTRACT

A first, a second, and a third gradations respectively corresponding to a first, a second, and a third display colors at a display unit having a plurality of spacers disposed between a first and a second substrates and pixels of the first, the second, and the third display colors different from one another, are corrected with corresponding to dispositions of the spacers on the display unit. The first, the second, and the third gradations are respectively corrected with corresponding to the dispositions of the spacers on the display unit, and thereby, irregularities in a display luminances in the vicinities of the spacers can be reduced with corresponding to the first, the second, and the third respective display colors.

### CROSS-REFERENCE TO THE INVENTION

This application is based upon and claims the benefit of priority from the prior Japanese Patent Application No. 2004-289378, filed on Sep. 30, 2004; the entire contents of which are incorporated herein by reference.

### BACKGROUND OF THE INVENTION

1. Field of the Invention

The present invention relates to a display device such as a field emission display in which spacers and pixels are disposed between substrates, and a display method on the display device.

2. Description of the Related Art

A development of a field emission display in which an electron emission element and a phosphor are arranged between two substrates and the phosphor is light emitted by electrons emitted from the electron emission element to display an image, has been in progress (refer to Japanese Patent Laid-open Application No. 2000-311607). To make the field emission display operate, it is required to reduce a pressure between the substrates. To achieve this, the spacers are disposed between the substrates and a distance between the substrates is kept against the atmospheric pressure.

### SUMMARY OF THE INVENTION

However, irregularities in a display may occur in vicinities of the spacers of the field emission display caused by an electrostatic charge of the spacers and so on.

In consideration of the above, the object of the present invention is to provide a display device and a display method capable of eliminating the irregularities in the display in the vicinities of the spacers.

A display device according to an aspect of the present invention, including: a display unit having a first and a second substrates disposed to face each other, a plurality of spacers disposed between the first and the second substrates, and pixels arranged between the first and the second substrates and having a first, a second, and a third display colors different from one another; a gradation correction unit configured to input image signals including information of a first, a second, and a third gradations corresponding to the first, the second, and the third respective display colors, and correcting the first, the second, and the third gradations respectively with corresponding to dispositions of the spacers on the display unit; and a drive signal generation unit configured to generate a drive signal to display the display unit based on the gradations corrected at the gradation correction unit.

### BRIEF DESCRIPTION OF THE DRAWINGS

FIG. 1 is a view showing a display device according to an embodiment of the present invention.

FIG. 2 is an upper surface view schematically showing a state in which a display panel in FIG. 1 is seen from an upper surface.

FIG. 3 is a side view showing a state in which the display panel in FIG. 1 is seen from a lateral direction.

FIG. 4 is a graph showing a correspondence between a position of a scanning line and a relative luminance of a display pixel.

FIG. 5 is a schematic view showing an example of contents of a gradation correction table.

FIG. 6 is a graph showing the contents of the gradation correction table shown in FIG. 5.

FIGS. 7A, FIG. 7B, FIG. 7C, and FIG. 7D are graphs showing examples of signal waveforms of signal line drive signals.

### DESCRIPTION OF THE EMBODIMENTS

Hereinafter, embodiments of the present invention are described in detail with reference to the drawings.

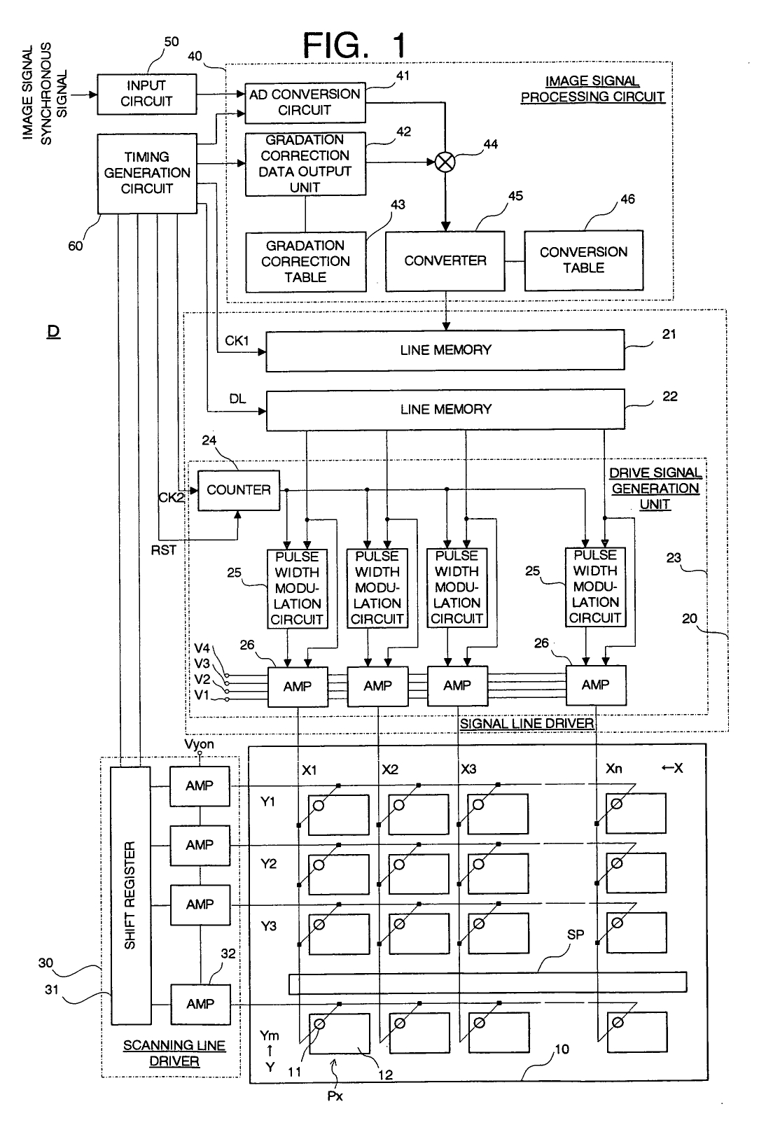

FIG. 1 is a view showing a display device D according to an embodiment of the present invention. The display device D includes a display panel 10, a signal line driver 20, a scanning line driver 30, an image signal processing circuit 40, an input circuit 50, and a timing generation circuit 60.

An image signal and a synchronous signal are inputted to the input circuit 50, and separately outputted to the image signal processing circuit 40 and the timing generation circuit 60 respectively. The image signal processing circuit 40 processes a correction and so on of the image signal inputted from the input circuit 50 to output to the signal line driver 20. The timing generation circuit 60 outputs an operation timing signal based on the synchronous signal inputted from the input circuit 50 to the scanning line driver 30, the image signal processing circuit 40, and the signal line driver 20.

The signal line driver 20 converts the image signal inputted from the image signal processing circuit 40 into a drive signal, and outputs the drive signal to the display panel 10. The scanning line driver 30 converts the operation timing signal inputted from the timing generation circuit 60 into a scanning line signal, and outputs the scanning line signal to the display panel 10. The display panel 10 displays an image based on the drive signal and the scanning line signal inputted from the signal line driver 20 and the scanning line driver 30.

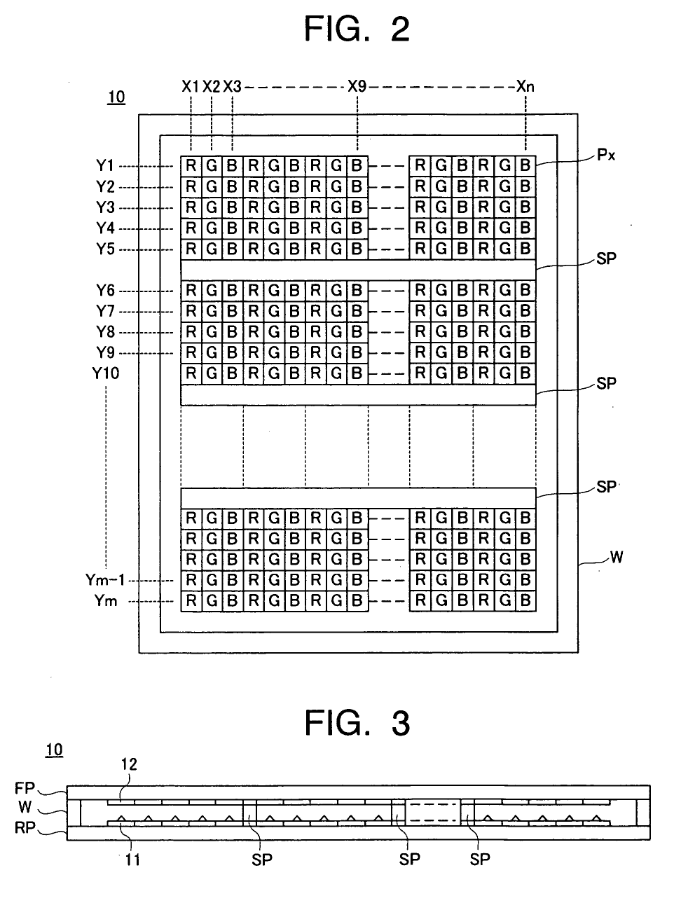

FIG. 2 is an upper surface view schematically showing a state in which the display panel 10 is seen from an upper surface. Besides, FIG. 3 is a side view showing a state in which the display panel 10 is seen from a lateral direction. The display panel,10 has a face plate FP, a rear plate RP, side walls W, spacers SP, scanning lines Y, signal lines X, and display pixels Px. Incidentally, in FIG. 2 and FIG. 3, the scanning lines Y and the signal lines X are not shown for easy to understanding of a disposition relationship between the display pixels Px and the spacers SP.

The face plate FP and the rear plate RP respectively function as a first and a second substrates, and they constitute a vacuum vessel together with the side walls W. Namely, a space (inside of the vacuum vessel) formed by the face plate FP, the rear plate RP, and the side walls W is reduced a pressure for the operation of the display panel 10, and it is in a high-vacuum state.

The spacers SP are for keeping intervals between the face plate FP and the rear plate RP. The pressure of the space between the face plate FP and the rear plate RP is reduced, and therefore, a force by an atmospheric pressure is applied, and the interval of the center may become smaller than the interval in the vicinities of the side walls W. The spacers SP have columnar shapes having approximately rectangle bottom surfaces being long and thin in a lateral direction, and they are arranged in a longitudinal direction with predetermined intervals.

The scanning lines Y and the signal lines X are disposed on the rear plate RP. The scanning lines Y (Y1 to Ym) of m (for example, 720) pieces extend in a lateral (horizontal) direction. The signal lines X (X1 to Xn) of n (for example, 1280×3) pieces extend in a longitudinal (vertical) direction while crossing these scanning lines Y1 to Ym.

Display pixels Px of m×n (for example, 720×1280×3=approximately 2,760,000) pieces are disposed in vicinities of intersection positions of these scanning lines Y1 to Ym and the signal lines X1 to Xn.

The display pixel Px has an electron emission element 11 and a phosphor 12. The electron emission element 11 is disposed on the rear plate RP, and is driven by the corresponding scanning line Y and the signal line X to emit electrons. The phosphor 12 is disposed on the face plate FP, and emits a light by an electron beam emitted from the electron emission element 11. This phosphor 12 emits the light with a display color of red (R), green (G), or blue (B). Namely, the display pixel Px corresponds to the display color of red (R), green (G), or blue (B).

The display pixels Px of red (R), green (G), and blue (B) are respectively disposed in the longitudinal direction. Here, the three display pixels Px of red (R), green (G), and blue (B) disposed to adjacent in the horizontal direction can be considered as one color pixel on the block. A full color display becomes possible by controlling these display pixels Px of red (R), green (G), and blue (B).

As shown in FIG. 2, the display pixels Px are disposed between the spacers SP. Incidentally, in FIG. 2, five display pixels Px are disposed between the spacers SP provided in the longitudinal direction for easy to understanding, but it isn't absolute. More display pixels Px may be disposed between the spacers SP. Besides, the number of the display pixels Px disposed between the spacers SP may not be constant.

In the vicinities of the spacers SP, irregularities in the display may occur on the display panel 10. The display pixel Px which is the nearest to the spacer SP (the most proximity display pixel (the display pixel Px corresponding to the scanning line Y5, Y6, Y10, or the like in FIG. 2)) tends to be darker than an original luminance thereof. Besides, the display pixel Px which is away from the spacer SP in comparison with the most proximity display pixel (the proximity display pixel (the display pixel Px corresponding to the scanning line Y4, Y7, Y9, or the like in FIG. 2)) tends to be brighter than the original luminance thereof. The display pixel Px which is away from the spacer SP in comparison with those emits a light with the original luminance thereof.

Namely, regions on the display panel 10 are sectionalized into a most proximity region, a proximity region, and a normal region according to a distance from the spacers SP, and the luminances at the respective regions become to be a low luminance, a high luminance, and a normal luminance to form bright and dark fringes in the vicinities of the spacers SP. Such an occurrence of the fringes may be a cause of the irregularity in the display on the display panel 10, and therefore, it is not preferable.

Incidentally, in the above description, it is explained that the display pixel Px included in each region is one, but the display pixels Px included in these regions may be plural, and the display pixel Px with an intermediate luminance may exist between the regions of the low luminance and the high luminance.

The occurrence of the bright and dark in the vicinity of the spacer SP can be described by an electrostatic charge of the spacer SP. When the spacer SP takes a charge, orbits of electrons from the electron emission element 11 to the phosphor 12 are influenced. For example, when the spacer SP is charged negative, the electrons flying in the vicinity of the spacer SP is away from the spacer. As a result, the number of electrons reaches the phosphor 12 in the most vicinity of the spacer SP decreases, and the number of electrons reaches the phosphor 12 which is away from the spacer SP in comparison with this most vicinity phosphor 12 increases. As a result, the display pixel Px in the most vicinity region from the spacer SP becomes the low luminance, and the display pixel Px in the vicinity region from the spacer SP becomes the high luminance.

To suppress the electrostatic charge of the spacer SP, it is conceivable that an electric conductivity is added to a surface of the spacer SP to remove the charged electric charges. However, it is difficult to eliminate the irregularity in the luminance in the vicinity of the spacer SP completely, and it is preferable to correct the luminance by some means.

Here, it turns out that the irregularity in the display pixel Px in the vicinity of the spacer SP differs also dependent on the display color of red (R), green (G), or blue (B) of the display pixel Px.

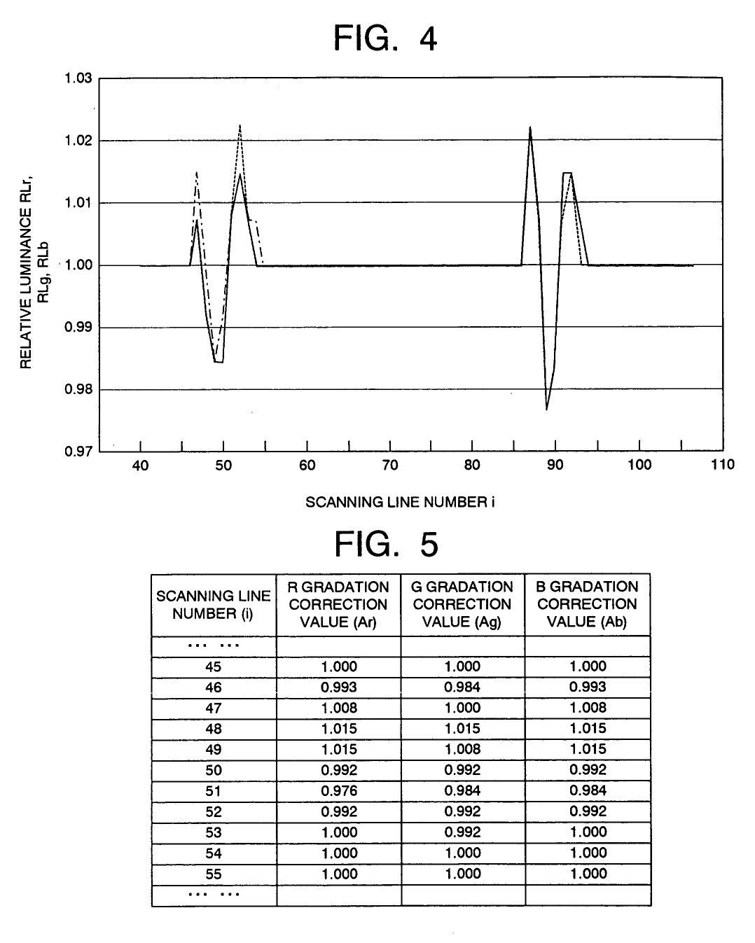

FIG. 4 is a graph showing a correspondence between a position of the scanning line Y and a relative luminance of the display pixel Px. A horizontal axis is a scanning line number i, and a vertical axis is a relative luminance RL (a luminance L of each display pixel Px is normalized by a reference luminance CL, relative luminance RL=luminance L/reference luminance CL).

The relative luminance RL is sectionalized into RLr, RLg, and RLb corresponding to the respective display colors of red (R), green (G), and blue (B). Namely, the respective relative luminances RLr, RLg, and RLb correspond to the display pixels Px of red (R), green (G), and blue (B) arranged in the longitudinal direction.

As shown in FIG. 4, in the respective red (R), green (G), and blue (B), for example, the low luminance region is disposed at a range of the scanning line numbers of 47 to 49, the high luminance regions are disposed at the scanning line number of 46, and the range of 50 to 53. However, in red (R), green (G), and blue (B), inconsistencies of approximately one line each (one display pixel) are seen within the range. Besides, slight inconsistencies can be seen in sizes of the relative luminances RL. As stated above, the relative luminances RLr, RLg, and RLb of the respective red (R), green (G), and blue (B) are not necessarily corresponding.

As a cause of the inconsistencies of the relative luminances RLr, RLg, and RLb, differences of materials and manufacturing processes of the phosphors 12 of red (R), green (G), and blue (B) are conceivable. For example, when the phosphors 12 are manufactured, the phosphors 12 for red (R), green (G), and blue (B) are respectively coated on the face plate FP by means of printing and so on. Displacements in the relative luminances RLr, RLg, and RLb of red (R), green (G), and blue (B) may occur caused by displacements of the printings of red (R), green (G), and blue (B) at this time.

The differences of materials and the displacements of the phosphors 12 for red (R), green (G), and blue (B) influence the electrostatic charge states and so on of the spacers SP, and there is a possibility to be a cause of a difference of the luminances in the vicinities of the spacers SP. It is difficult to completely eliminate the irregularities in the luminances of red (R), green (G), and blue (B) in the vicinities of the spacers SP, and therefore, it is preferable to correct the luminances of red (R), green (G), and blue (B) by some means.

The signal line driver 20, the scanning line driver 30, the image signal processing circuit 40, the input circuit 50, and the timing generation circuit 60 are used as drive circuits of the display panel 10, and they are disposed around the display panel 10. The signal line driver 20 is connected to the signal lines X1 to Xn, and the scanning line driver 30 is connected to the scanning lines Y1 to Ym.

The input circuit 50 inputs an analog RGB image signal and the synchronous signal supplied from an external signal source, supplies the image signal processing circuit 40 with the image signal, and supplies the timing generation circuit 60 with the synchronous signal.

The image signal processing circuit 40 performs a signal processing for the image signal from the input circuit 50.

The timing generation circuit 60 controls the operation timings of the signal line driver 20, the scanning line driver 30, and the image signal processing circuit 40 based on the synchronous signal. By this control, the scanning line driver 30 sequentially drives the scanning lines Y1 to Ym by using the scanning signal. The signal line driver 20 drives the signal lines X1 to Xn by the signal line drive signal in a voltage pulse method while the respective scanning lines Y1 to Ym are driven by the scanning line driver 30.

The image signal processing circuit 40 has an AD conversion circuit 41, a gradation correction data output unit 42, a gradation correction table 43, a multiplier 44, a converter 45, and a conversion table 46.

The AD conversion circuit 41 converts the analog RGB image signal supplied from the input circuit 50 in synchronize with a horizontal synchronous signal into a digital format. In the AD conversion circuit 41, the analog RGB image signal is converted into, for example, a 10 bits gradation data capable of displaying 1024 gradations, for the respective display pixels Px.

The gradation correction data output unit 42, the gradation correction table 43, and the multiplier 44 function as gradation correction units as a whole to correct a first, a second, and a third respective gradations with corresponding to the dispositions of the spacers on the display unit.

The gradation correction data output unit 42 outputs a gradation correction data to correct the luminance of the display pixel Px. The gradation correction data is outputted in accordance with the number i of the scanning lines Y and the display color of red (R), green (G), or blue (B) based on the timing signal from the timing generation circuit 60. The number i of the scanning lines Y is judged from the vertical synchronous signal, the display color is judged from the horizontal synchronous signal, and the gradation correction table 43 is referenced to determine a gradation correction value.

The gradation correction table 43 is a table used for an output of the gradation correction data at the gradation correction data output unit 42.

FIG. 5 is a schematic view showing an example of contents of the gradation correction table 43. The number i of the scanning lines Y and gradation correction values Ar, Ag, and Ab of the respective colors of red (R), green (G), and blue (B) are shown correspondingly. Besides, FIG. 6 is a graph showing the contents shown in FIG. 5 as the table. A horizontal axis is the scanning line number i, and a vertical axis is the gradation correction values Ar, Ag, and Ab of the respective colors of red (R), green (G), and blue (B). In these FIG. 5 and FIG. 6, the gradation correction values to correct the relative luminances of RLr, RLg, and RLb shown in FIG. 4 are shown.

The multiplier 44 multiplies the gradation value outputted from the AD conversion circuit 41 by the gradation correction value outputted from the gradation correction data output unit 42. As a result of this multiplication, the gradation data is corrected, and nonuniformities of the respective gradations of red (R), green (G), and blue (B) in the vicinities of the spacers as shown in FIG. 4 are corrected.

The converter 45 converts the gradation data outputted from the multiplier 44 into a value being compatible with a voltage pulse method of the signal line drive signal. The conversion table 46 is referenced during this conversion.

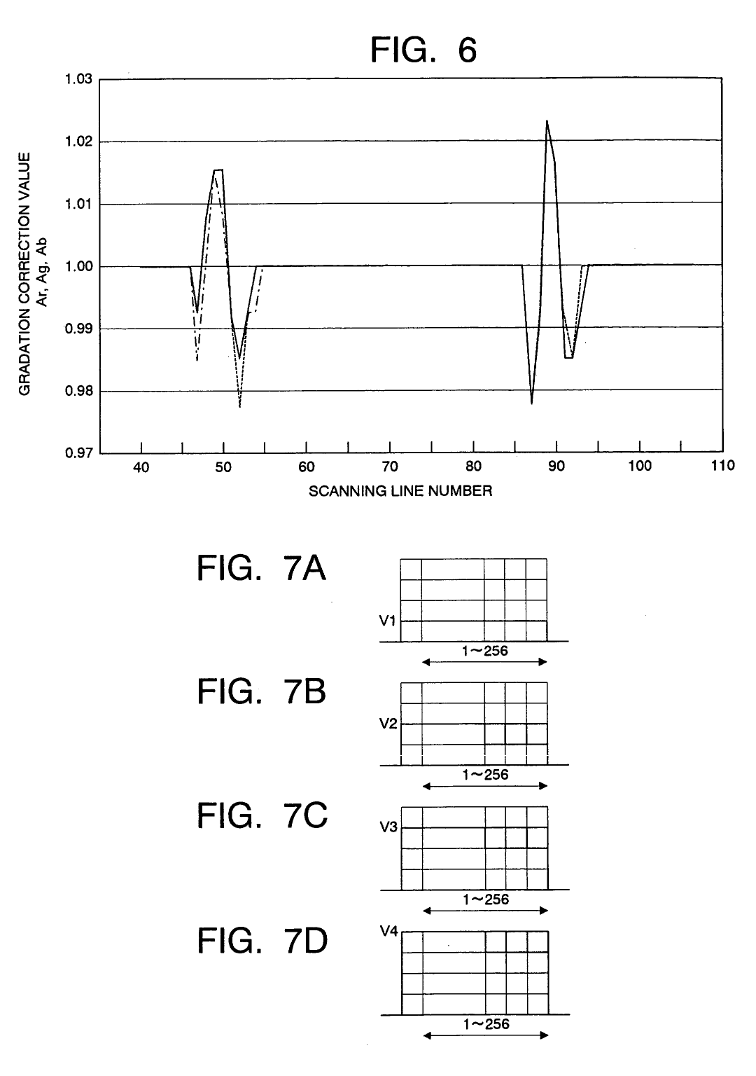

The conversion table 46 stores 11 bits conversion data of 1024 pieces allocated to every gradation value of the gradation data outputted from the multiplier 44. Concretely speaking, the gradations of 0 to 256 are converted to 0 to 256, the gradations of 257 to 512 are converted to 512 to 769, the gradations of 513 to 768 are converted to 1024 to 1280, and the gradations of 769 to 1024 are converted to 1536 to 1792, respectively. Upper two bits and lower nine bits of the gradation data after conversion respectively correspond to a pulse amplitude (element voltages V1 to V4) and a pulse width (time length of 0 to 256) of the signal line drive signal. Incidentally, the details of the signal line drive signal will be explained later with FIG. 7A to FIG. 7D.

The signal line driver 20 includes line memories 21 and 22, and a drive signal generation unit 23.

The line memory 21 makes a sampling of the image signals within one horizontal line while synchronizing with a clock CK1 supplied from the timing generation circuit 60 during respective horizontal scanning period, and outputs these image signals, namely the gradation data of n pieces in parallel.

The line memory 22 latches the gradation data in response to a latch pulse DL supplied from the timing generation circuit 60 in a state in which every gradation data is outputted from the line memory 21, and holds the gradation data during the following one horizontal scanning period when the line memory 21 makes the sampling operation again.

The drive signal generation unit 23 generates the signal line drive signal composed of the voltage pulses of n pieces having the pulse amplitudes and the pulse widths respectively corresponding to the gradation data outputted in parallel from the line memory 22, to supply to the signal lines X1 to Xn. The drive signal generation unit 23 includes a counter 24, pulse width modulation circuits 25 of n pieces, and output buffer amplifiers 26 of n pieces.

The counter 24 has a 10-bit configuration, and it is initialized in response to a reset signal RST supplied from the timing generation circuit 60 in accordance with a start of the respective horizontal scanning periods. The counter 24 is then counted up by a clock CK2, supplied from the timing generation circuit 60 subsequently to the reset signal RST. After that, the counter 24 outputs a 10 bits count data representing an effective image period within the respective horizontal scanning periods by a time length of 1024 steps.

The respective pulse width modulation circuits 25 are composed of, for example, comparators, and compares a corresponding gradation data supplied from the line memory 22 with the count data supplied from the counter 24, to output the voltage pulse having the same pulse width with a period until the count data reaches the gradation data.

The respective output buffer amplifiers 26 select and output positive element voltages V1, V2, V3, and V4 which are externally supplied, based on the upper two bits of the gradation data supplied to the corresponding pulse width modulation circuits 25. Consequently, the voltage pulse from the pulse width modulation circuit 25 is amplified to the same pulse amplitude as any one of these element voltages V1, V2, V3, and V4. At this time, a selected element voltage is outputted from the output buffer amplifier 26 during the same period as the pulse width of the pulse voltage from the pulse width modulation circuit 25. Namely, the output buffer amplifier 26 outputs the signal line drive signal having the pulse amplitude and the pulse width depending on the gradation value of the gradation data.

FIG. 7A to FIG. 7D are graphs showing examples of signal waveforms of the signal line drive signals.

The signal line drive signal is sectionalized into four regions from (A) to (D) in accordance with the strength of the image signal, and has different amplitude values V1 to V4 by every region. These regions (A) to (D) respectively correspond to the gradation values before conversion at the converter 45 of 0 to 256, 257 to 512, 513 to 768, and 769 to 1024, and the upper two bits of the gradation data after conversion at the converter 45 of “00”, “01”, “01”, and “11”.

The amplitude values V1 to V4 of the drive signal are enlarged step by step in the respective regions, and further, the pulse widths are made to be variable with corresponding to the values of the image signals in the respective regions, and thereby enabling a fine-grained gradation expression.

As shown in FIG. 7A, when the gradation value is 0 to 256, the signal line drive signal has a pulse with the pulse amplitude of the element voltage V1 and the pulse width being the time length of 0 to 256. As shown in FIG. 7B, when the gradation value is 257 to 512, the signal line drive signal has a combination of a pulse with the pulse amplitude of the element voltage V2 and the pulse width being the time length of 0 to 256, and a pulse with the pulse amplitude of the element voltage V1 and the pulse width being the time length of the rest (to 256). As shown in FIG. 7C, when the gradation value is 513 to 768, the signal line drive signal has a combination of a pulse with the pulse amplitude of the element voltage V3 and the pulse width being the time length of 0 to 256, and a pulse with the pulse amplitude of the element voltage V2 and the pulse width being the time length of the rest (to 256). As shown in FIG. 7D, when the gradation value is 769 to 1024, the signal line drive signal has a combination of a pulse with the pulse amplitude of the element voltage V4 and the pulse width being the time length of 0 to 256, and a pulse with the pulse amplitude of the element voltage V3 and the pulse width being the time length of the rest (to 256).

The scanning line driver 30 includes a shift register 31 and an output buffer amplifier 32.

The shift register 31 shifts a vertical synchronization signal by every one horizontal scanning period to output from one of output terminals of m pieces. The output buffer amplifier 32 responds to pulses from the output terminals of m pieces of the shift register 31 respectively, to output the scanning signals to the scanning lines Y1 to Ym.

The scanning signals outputted from the output buffer amplifier 32 are negative voltage Vy on supplied from a scanning voltage terminal, and they are outputted only for one horizontal scanning period.

At each electron emission element 11, a discharge may occur when the element voltage vf between electrodes composed of the signal line X and the scanning line Y exceeds a threshold, and the electron beam emitted by this excites the phosphor 12. Luminances of the respective display pixels Px is controlled by a drive current Ie flowing in the electron emission element 11 depending on the pulse width and the pulse amplitude of the signal line drive signal.

The gradations of the respective red (R), green (G), and blue (B) in the vicinities of the spacers SP are corrected by the gradation correction data output unit 42, and thereby, the nonuniformities of the luminances in the vicinities of the spacers SP are corrected, and images displayed on the display panel 10 become clearer.

### Other Embodiments

Embodiments of the present invention can be expanded/modified without being limited to the above-described embodiment, and such expanded/modified embodiments are also included in the technical scope of the present invention.

What is claimed is:

1. A display device, comprising:
a display unit having a first and a second substrates disposed to face each other, a plurality of spacers disposed between the first and the second substrates, and pixels arranged between the first and the second substrates and having a first, a second, and a third display colors different from one another;
a gradation correction unit configured to input image signals including information of a first, a second, and a third gradations corresponding to the first, the second, and the third respective display colors, and correcting the first, the second, and the third gradations respectively with corresponding to dispositions of the spacers on the display unit; and
a drive signal generation unit configured to generate a drive signal to display the display unit based on the corrected gradations.

2. A display device according to claim 1,
wherein the pixel includes an electron emission element and a phosphor emitting a light of either one of the first, the second, or the third display color by electrons emitted from the electron emission element.

3. A display device according to claim 1,
wherein the pixels of the first, the second, and the third display colors are respectively arranged so as to intersect with the spacers.

4. A display device according to claim 1,
wherein said gradation correction unit corrects the gradation relating to the pixel in a vicinity of the spacer.

5. A display device according to claim 3,
wherein said gradation correction unit makes the correction so that the gradation relating to the pixel in a first vicinity of the spacer becomes large and the gradation relating to the pixel in a second vicinity which is away from the spacer in comparison with the first vicinity becomes small.

6. A display device according to claim 1,
wherein said drive signal generation unit varies an amplitude and a pulse width of the drive signal with corresponding to the gradation.

7. A display method, comprising:
inputting an image signal including information of a first, a second, and a third gradations respectively corresponding to a first, a second, and a third display colors at a display unit having a first and a second substrates disposed to face each other, a plurality of spacers disposed between the first and the second substrates, and pixels arranged between the first and the second substrates and having the first, the second, and the third display colors different from one another;
correcting the first, the second, and the third respective gradations included in the inputted image signal with corresponding to the dispositions of the spacers on the display unit; and
generating a drive signal to display the display unit based on the corrected gradations.

8. A display method according to claim 7,
wherein the pixel includes an electron emission element and a phosphor emitting a light of either the first, the second, or the third display color by electrons emitted from the electron emission element.

9. A display method according to claim 7,
wherein the respective pixels of the first, the second, and the third display colors are arranged so as to intersect with the spacers.

10. A display method according to claim 7,
wherein said correcting gradations step includes a step correcting gradation relating to the pixel in the vicinity of the spacer.

11. A display method according to claim 7,
wherein said correcting gradations step includes a step correcting the gradation relating to the pixel in a first vicinity of the spacer to be large, and the gradation relating to the pixel in a second vicinity which is away from the spacer in comparison with the first vicinity to be small.

12. A display method according to claim 7,
wherein said generating the drive signal step includes a step varying an amplitude and a pulse width of the drive signal in accordance with the gradation.
